(19) United States
(12) Patent Application Publication
(10) Pub. No.: US 2013/0264906 A1
(43) Pub. Date: Oct. 10, 2013

(54) Multi-Layer Brush

(71) Applicant: JOHNSON ELECTRIC S.A., Murten (CH)

(72) Inventors: James Ching Sik LAU, Shatin (HK); Jing Chao ZHENG, Shatin (HK)

(73) Assignee: Johnson Electric S.A., Murten (CH)

(21) Appl. No.: 13/857,728

(22) Filed: Apr. 5, 2013

(30) Foreign Application Priority Data
Apr. 9, 2012 (CN) 201210100631.1

(51) Int. Cl. H01R 39/24

(52) U.S. Cl. CPC H01R 39/24
USPC 310/251

(57) ABSTRACT

A multi-layer brush for making sliding contact with a commutator of an electric motor, includes a body and a shunt. The body includes a first electrically conductive layer, a second electrically conductive layer, and a partition layer disposed between the first and second conductive layers and electrically separating the first and second conductive layers. The shunt is coupled to the first conductive layer. The first conductive layer has a thickness greater than a thickness of the second conductive layer and the partition layer has a lateral leakage resistance greater than the longitudinal resistance of the first and second conductive layers.

### CROSS REFERENCE TO RELATED APPLICATIONS

This non-provisional patent application claims priority under 35 U.S.C. §119(a) from Patent Application No. 201210100631.1 filed in The People's Republic of China on Apr. 9, 2013.

### FIELD OF THE INVENTION

This invention relates to a brush of an electric motor and in particular, to a multi-layer brush.

### BACKGROUND OF THE INVENTION

A typical brushed motor comprises a stator, a rotor, brushes and a commutator. The rotor has windings electrically connected to segments of the commutator which is fixed to a shaft of the rotor. As the rotor rotates, the brushes pass over the commutator and sequentially contact the segments of the commutator to supply electrical power to the windings via the commutator.

A traditional brush usually has only one layer made of electrically conductive material. During commutation, arcing occurs between the brush and the segment, which results in the brush over-heating and generation of electromagnetic interference (EMI).

### SUMMARY OF THE INVENTION

Hence there is a desire for an improved brush that suppresses arcing and therefore reduces EMI.

Accordingly, in one aspect thereof, the present invention provides a multi-layer brush for sliding contact with a commutator of an electric motor, the brush comprising: a body comprising: a first electrically conductive layer having a longitudinal resistance; a second electrically conductive layer having a longitudinal resistance; and a partition layer having a lateral leakage resistance, disposed between the first and second conductive layers to electrically separate the first conductive layer from the second conductive layer; and a shunt coupled to the first electrically conductive layer; wherein the first conductive layer has a thickness greater than a thickness of the second conductive layer and the lateral leakage resistance the partition layer is greater than the longitudinal resistance of the first and second conductive layers.

Preferably, no wire or conductor is connected between the first and second conductive layers.

Preferably, the longitudinal resistance of the second conductive layer is greater than the longitudinal resistance of the first conductive layer.

Preferably, the thickness of the second conductive layer is less than one third of the thickness of the first conductive layer.

Preferably, the lateral leakage resistance of the partition layer is greater than ten times the longitudinal resistance of the first conductive layer.

Preferably, the body comprises two second conductive layers disposed on opposite sides of the first, conductive layer, and two partition layers respectively sandwiched between the first conductive layer and the second conductive layers.

Preferably, an interface formed between the first and second conductive layers has a wave configuration.

Preferably, a capacitor is connected between the first and second conductive layers and is embedded in an end of the body adjacent the shunt.

In another aspect thereof, the present invention provides an electric motor comprising: a stator; a rotor, including a commutator having a plurality of spaced conductive segments; and brush gear for supplying electrical power to the rotor via the commutator, wherein the brush gear includes a multi-layer brush as described above, arranged to make sliding contact with segments of the commutator.

Preferably, the thickness of the second conductive layer is greater than a width of a space formed between adjacent segments of the commutator.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a brush according to a first preferred embodiment of the present invention;

FIG. 2 illustrates a commutator and windings of an electric motor and the brush of FIG. 1;

FIG. 3 is a view similar to FIG. 2, showing the brush located at another position relative to the commutator;

FIG. 4 illustrates a brush according to a second preferred embodiment of the present invention;

FIG. 5 illustrates a brush according to a third preferred embodiment of the present invention;

FIG. 6 illustrates a brush according to a fourth preferred embodiment of the present invention; and

FIG. 7 illustrates an electric motor incorporating a multi-layer brush according to the present invention.

### DETAILED DESCRIPTION OF THE PREFERRED EMBODIMENTS

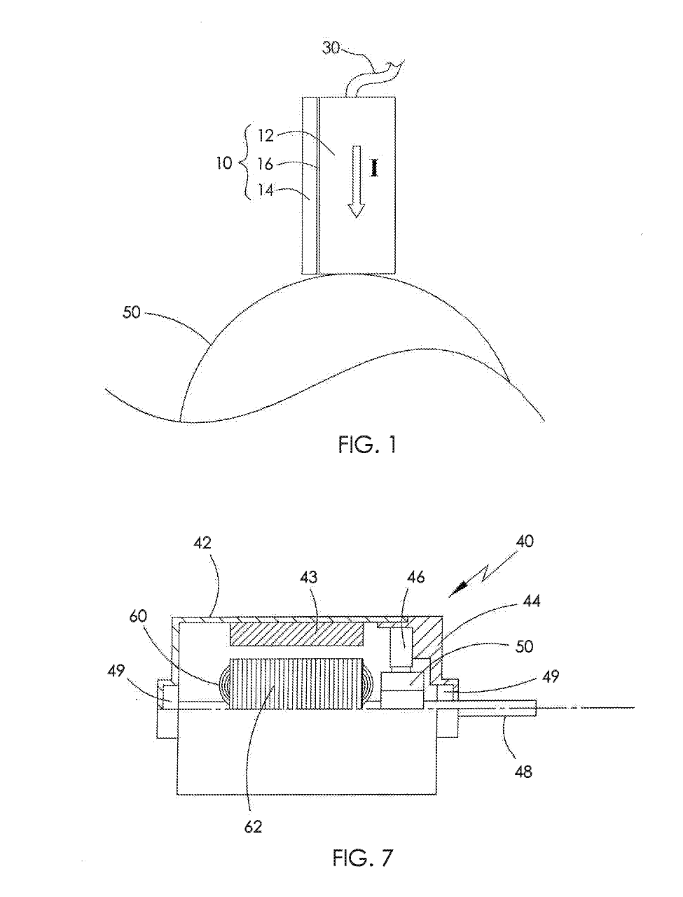

Referring to FIGS. 1 to 3, a multi-layer brush according to a first preferred embodiment of the present invention comprises a body 10 configured to slidingly contact with segments 51-53 of a commutator 50 of an electric motor and a shunt 30 configured to connect the body 10 with a conductive terminal (not shown) of the electric motor.

In the present invention, the body 10 defines a longitudinal direction which is parallel to a radial direction of the commutator 50, and a lateral direction which is tangential to the commutator, i.e. the direction the layers are stacked.

The body 10 comprises a first electrically conductive layer 12, a second electrically conductive layer 14 and a partition layer 16 sandwiched between the first and second conductive layers 12,14. In this embodiment, the first conductive layer 12 acts as the main conductive layer which is mechanically and electrically coupled to the shunt 30. The thickness of the first conductive layer 12 in the lateral direction of the body 10 is greater than that of the second conductive layer 14. The first conductive layer 12 and the second conductive layer 14 may be made of materials with the same resistivity or made of materials with different resistivities. One end of the body 10 in the longitudinal direction thereof remote from the shunt 30 is configured to make sliding contact with the segments 51-53 of the commutator 50.

Preferably, the longitudinal resistance of the second conductive layer 14 in the longitudinal direction of the body 10 is greater than the longitudinal resistance of the first conductive layer 12, The longitudinal resistance is the resistance measured in the longitudinal direction of the brush. The thickness of the second conductive layer .14 is less than the thickness of the first conductive layer 12. In this embodiment of the present invention, the thickness of the second conductive layer 14 is less than one third of the thickness of the first conductive layer 12. The thickness dimension is measured in the lateral direction of the brush as shown in the figures, which is the stacking direction of the layers.

The shunt 30 has one end fixed and connected to the first conductive layer 12 and the other end electrically coupled to a conductive terminal of an electric motor which is configured to be electrically coupled to a power source. The shunt 30 does not extend through the electrically insulating layer 16 to enter in the second conductive layer 14. No wire or conductor outside of the body 10 electrically connects the second conductive layer 14 to the shunt 30. There are no wires or conductors extending through the electrically insulating layer 16 to electrically connect the first and second conductive layers 12, 14. Thus, the second conductive layer 14 is not electrically coupled to the conductive terminal of the motor.

Preferably, the partition layer 16 is made of an electrically insulating material for electrically insulating the first and second conductive layers 12, 14. Thus, the structure of the body 10 is like that of a capacitor. Electricity coming from the shunt 30 passes through the body 10 via the first conductive layer 12 in the longitudinal direction thereof as shown by the arrow I of FIG. 1.

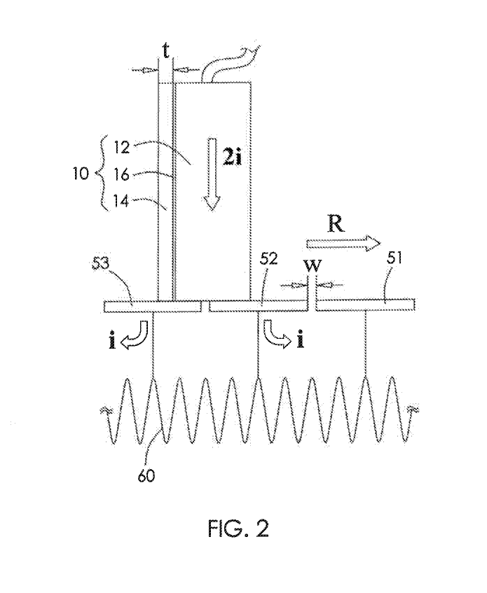

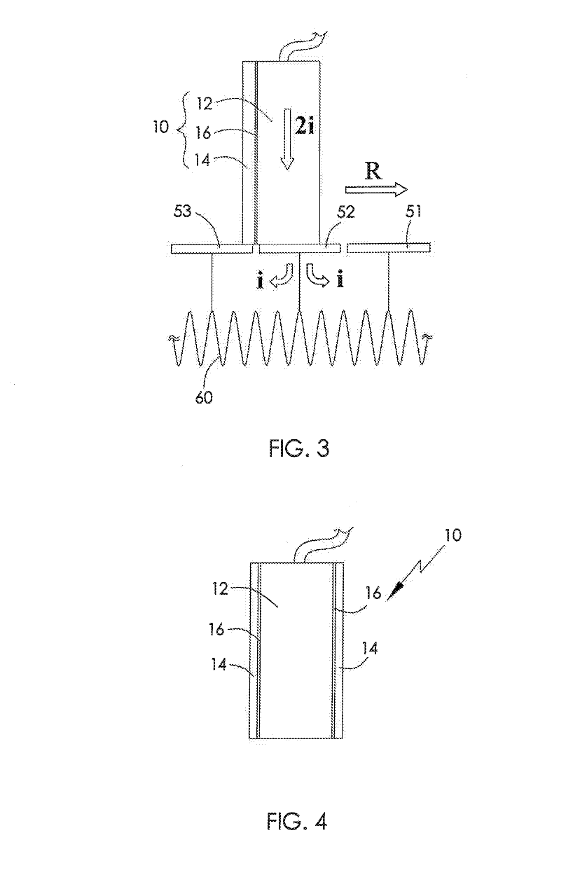

FIGS. 2 and 3 show a commutator in a developed state (i.e. laid flat) the brush of FIG. 1 in two different positions. The commutator 50 comprises a plurality of segments (only three segments 51-53 shown) electrically connected to windings 60. In this embodiment, the rotor of the electric motor rotates in a direction as shown by the arrow R. Thus, with respect to each segment, the first conductive layer 12 leaves the segment earlier than the second conductive layer 14. As shown in FIG. 2, the first conductive layer 12 partly leaves segment 53 and contacts both segments 52 and 53. At this stage, no current passes through the winding 60 connected between segments 52 and 53. When the rotor rotates further to the position shown in FIG. 3, the first conductive layer 12 completely leaves segment 53 and only contacts segment 52. The second conductive layer 14 still contacts segment 53. Current i passes through the winding 60 connected between the segments 52 and 53. At the moment the rotor changes from the position of FIG. 2 to the position of FIG. 3, current flowing through the winding 60 connected between segments 52, 53 changes from zero to i immediately. An induced voltage is therefore generated between the two ends of the winding 60 which are respectively connected to the first and second conductive layers 12, 14 via the corresponding segments 52, 53. The body 10 of the brush, functioning like a capacitor, provides a path for the induced voltage thus avoiding arcing or sparks at the moment of the first conductive layer 12 leaving the segment 53.

Referring to FIG. 2, t represents the thickness of the second conductive layer 14 and w represents the width of the space formed between adjacent segments. Preferably, t is greater than w in order to provide enough time to allow the induced voltage generated in the winding 60 to be dissipated.

Understandably, it is very hard to make a completely insulating partition layer. Many tests prove that if the lateral leakage resistance of the partition layer 16 of the brush is large enough the brush has a good effect of suppressing sparks. Preferably, the lateral leakage resistance of the partition layer 16 is greater than ten times the longitudinal resistance of the first conductive layer 12.

FIG. 4 shows a brush in accordance with a second embodiment of the present invention. The body 10 of the brush comprises a first conductive layer 12 and a pair of second conductive layers 14 on opposite sides of the first conductive layer 12. A partition layer 16 is disposed between each second conductive layer 14 and the first conductive layer 12 to electrically isolate the second conductive layers from the first conductive layer. The brush of FIG. 4 is suitable for an electric motor that is required to operate in both directions.

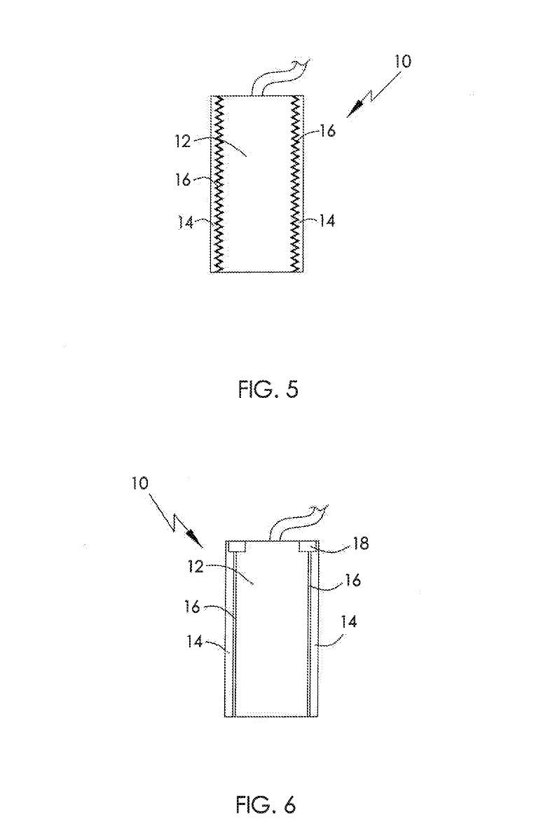

FIG. 5 shows a brush in accordance with a third embodiment of the present invention. In the third embodiment, the interfaces formed between the partition layer 16 and the first and second conductive layers 12, 14 are wave-shaped (i.e. wavy) in order to increase the contact surface area between the partition layer 16 and the first and second conductive layers 12, 14 to thereby increase the capacitance of the body 10 of the brush.

FIG. 6 shows a brush in accordance with a fourth embodiment of the present invention. In the fourth embodiment, a pair of capacitors 18 is embedded in the body 10 and respectively disposed between the first and second conductive layers 12, 14 in order to increase the capacitance of the body 10. Each capacitor 18 has a pair of parallel conductive plates respectively mechanically and electrically connected to the first and second conductive layers 12, 14. Preferably, the capacitors 18 are located at the end of the body 10 adjacent to the shunt 30. Thus, the body 10 with the capacitors 18 still has sufficient capacitance when the body 10 is worn to a short length. Alternatively, the capacitors 18 may be located outside of the body 10 and the parallel conductive plates thereof are respectively electrically connected to the first and second conductive layers 12, 14 via lead wires.

FIG. 7 illustrates an electric motor 40 incorporating a multi-layer brush according to the present invention. The motor 10 has a housing 42. The housing has at least one magnet 43 fixed to an inner surface. The housing and magnet form the stator of the motor. The housing has at least one open end that is closed by an end cap 44. Preferably the end cap is made of an insulating plastic material such as nylon or similar and directly supports brush gear 46. A rotor, comprising a shaft 48 rotatably supported by bearings 49 respectively fixed to the housing and end cap, a commutator 50 and a rotor core 62 fixed to the shaft. Windings 60 are wound about poles of the rotor core and are connected to segments of the commutator. The brush gear comprises a number of brushes arranged to make sliding contact with the commutator. At least one, but preferably, each brush is a multi-layer brush as described herein before, in accordance with the present invention. Preferably, each brush is slidably disposed in a brush cage arranged to guide the brush to the commutator and urged into sliding contact with the commutator by a spring (not shown).

in the description and claims of the present application, each of the verbs “comprise”, “include”, “contain” and “have”, and variations thereof, are used in an inclusive sense, to specify the presence of the stated item but not to exclude the presence of additional items.

Although the invention has been described with reference to one or more preferred embodiments, it should be appreciated by those skilled in the art that various modifications are possible. Therefore, the scope of the invention is to be determined by reference to the claims that follow.

1. A multi-layer brush for sliding contact with a commutator of an electric motor, the brush comprising:
a body comprising:
a first electrically conductive layer having a longitudinal resistance;
a second electrically conductive layer having a longitudinal resistance; and
a partition layer having a lateral leakage resistance, disposed between the first and second conductive layers; and
a shunt coupled to the first conductive layer;
wherein the first conductive layer has a thickness greater than a thickness of the second conductive layer and the lateral leakage resistance the partition layer is greater than the longitudinal resistance of the first and second conductive layers.

2. The brush of claim 1, wherein no wire or conductor is connected between the first and second electrically conductive layers.

3. The brush of claim 1, wherein the longitudinal resistance of the second conductive layer is greater than the longitudinal resistance of the first conductive layer.

4. The brush of claim 1, wherein the thickness of the second conductive layer is less than one third of the thickness of the first conductive layer.

5. The brush of claim 1, wherein the lateral leakage resistance of the partition layer is greater than ten times the longitudinal resistance of the first conductive layer.

6. The brush of claim 1, wherein the partition layer is made of an electrically insulating material.

7. The brush of claim 1, wherein the body comprises two second conductive layers disposed on opposite sides of the first conductive layer, and two partition layers respectively sandwiched between the first conductive layer and the second conductive layers.

8. The brush of claim 1, wherein an interface formed between the first and second conductive layers has a wave configuration.

9. The brush of claim 1, wherein a capacitor is connected between the first and second conductive layers.

10. The brush of claim 9, wherein the capacitor s embedded in one end of the body adjacent the shunt.

11. An electric motor comprising:
a stator;
a rotor, including a commutator having a plurality of spaced conductive segments; and
brush gear for supplying electrical power to the rotor via the commutator, the brush gear including a multi-layer brush arranged to make sliding contact with segments of the commutator, the brush comprising:
a body comprising:
a first electrically conductive layer;
a second electrically conductive layer; and
a partition layer disposed between the first and second conductive layers; and
a shunt coupled to the first conductive layer;
wherein the partition layer has a lateral leakage resistance greater than longitudinal resistance of the first and second conductive layers and the lateral leakage. resistance of the partition layer is greater than ten times the longitudinal resistance of the first conductive layer.

12. The electric motor of claim 11, wherein the thickness of the second conductive layer is greater than a width of a space formed between adjacent segments of the commutator.

13. The electric motor of claim 11, wherein the first conductive layer has a thickness greater than a thickness of the second conductive layer.

14. The electric motor of claim 11, wherein the. thickness of the second conductive layer is less than one third of the thickness of the first conductive layer.

15. The electric motor of claim 11, wherein the partition layer is made of an electrically insulating material.

16. The electric motor of claim 11, wherein an interface formed between the first and second conductive layers has a wave-shaped configuration.

17. The electric motor of claim 11, wherein a capacitor is embedded in one end of the body near to the shunt and electrically connected between the first and second layer.
